(19) United States
(12) Patent Application Publication
(10) Pub. No.: US 2015/0015110 A1
(43) Pub. Date: Jan. 15, 2015

(54) Electric Rotating Machine

(71) Applicant: Hitachi Automotive Systems, Ltd., Hitachinaka-shi, Ibaraki (JP)

(72) Inventors: Tomoaki Kaimori, Hitachinaka (JP); Yoshimi Mori, Hitachinaka (JP); Takahiro Ohmori, Hitachinaka (JP); Kenichi Nakayama, Hitachinaka (JP)

(21) Appl. No.: 14/378,512

(22) PCT Filed: Jan. 15, 2013
(86) PCT No.: PCT/JP2013/050505

§ 371 Date: Aug. 13, 2014

(30) Foreign Application Priority Data
Mar. 23, 2012 (JP) 2012-066504

(51) Int. Cl. H02K 3/34; H02K 3/12; H02K 3/28; H02K 1/16

(52) U.S. Cl. CPC H02K 3/34; H02K 1/16; H02K 3/12; H02K 3/28
USPC 310/201

(57) ABSTRACT

An electric rotating machine is provided that can ensure insulation quality between a coil end and an inside wall of a housing or of a case. The electric rotating machine includes a stator including a stator core and a stator winding. The stator core has a plurality of slots rowed in a circumferential direction. The stator winding is formed of a conductor rectangular in a cross section and is inserted into the slots, the conductor being provided with an insulating coated layer. The stator winding has a first segment transition bent section provided on a radially outside of the stator and a second segment transition bent section provided on a radially inside of the stator. The first segment transition bent section has a layer-transition bent section angle greater than a layer-transition bent section angle of the second segment transition bent section.

### TECHNICAL FIELD

The present invention relates to an electric rotating machine.

### BACKGROUND ART

Electric rotating machines used for driving vehicles have been required to be downsized and to provide higher output power. To meet such requirements, rectangular wires are used to improve a space factor and output power. One of the winding methods employed in this case is a winding method in which rectangular wire segments are used.

This winding method involves inserting a rectangular wire formed in a U-shape into a stator core, circumferentially twisting straight portions of the rectangular wire projecting from the stator core, and connecting the straight portions thus twisted to a rectangular wire in a different slot. If a stator core having bolt insertion holes is directly attached to a motor housing or a transmission case by means of a bolt, or if a stator is shrinkage-fitted to a housing, then the inside wall of the housing or of the case will come close to coil ends located at both ends of the stator core. In such a case, a problem sometimes occurs with insulation quality between the rectangular wire and the inside wall of the housing or of the case.

Patent Document 1 discloses an electric rotating machine for vehicle in which a turn portion included in a small-sized segment has a first crank which radially shifts a conductor wire by almost the same distance as the radial width of the small-sized segment. In addition, a turn portion of a large-sized segment has a crank portion which radially shifts the conductor wire by almost the same distance as a value obtained by multiplying the radial width of the small-sized segment by two and further adding the radial width of the large-sized segment thereto.

### PRIOR-ART DOCUMENT

### Patent Document

Patent Document 1: JP-2006-149049-A

### SUMMARY OF THE INVENTION

### Problem to be Solved by the Invention

Patent Document 1 describes the electric rotating machine for vehicle that prevents the coil end from projecting in the radial direction in the case where the segments are stacked for use. However, Patent Document 1 does not describe insulation quality between a coil end and a housing or a case.

A conventional rectangular wire stator is such that a stator core is formed with a bolt hole. The stator core is directly attached to a housing or a case. In such a method, the housing or the case and a coil end come so close to each other that sufficient insulation quality may not be ensured.

It is an object of the present invention, therefore, to provide an electric rotating machine that can ensure insulation quality between a coil end and an inside wall of a housing or of a case.

### Means for Solving the Problem

To solve the above problem, for example, the structures described in claims are adopted. The present application includes a plurality of means for solving the above problem. One of the examples of such means is as below. An electric rotating machine is configured to comprise a stator including a stator core and a stator winding, the stator core having a plurality of slots rowed in a circumferential direction, the stator winding being formed of a conductor rectangular in a cross section and inserted into the slots, the conductor being provided with an insulating coated layer. The stator winding has a first segment transition bent section provided on a radially outside of the stator and a second segment transition bent section provided on a radially inside of the stator. The first segment transition bent section has a layer-transition bent section angle greater than does the second segment transition bent section.

### Effect of the Invention

The present invention can provide the electric rotating machine that can ensure insulation quality between a coil end and the inside wall of a housing or of a case.

Problems, structures, and advantages other than the above will become more apparent from the description of the embodiment as below.

### BRIEF DESCRIPTION OF DRAWINGS

FIG. 1 is a schematic structural diagram of a hybrid electric automobile on which electric rotating machines of a first embodiment are mounted.

FIG. 2 is a cross-sectional view of the electric rotating machine in FIG. 1.

FIG. 3 is a cross-sectional view illustrating a stator and a rotor in FIG. 2.

FIG. 4 is a perspective view illustrating the stator of FIG. 2.

FIG. 5 illustrates an end peeling method for an end of a rectangular wire and of a neutral wire.

FIG. 6 illustrates the stator of FIG. 2 as vertically viewed in an axial direction.

FIG. 7 illustrates the shape of a winding of a conventional stator.

FIG. 8 illustrates the shape of a winding of the stator according to the present invention as viewed from an axial direction.

FIG. 9 illustrates the shape of the winding of the stator according to the present invention.

### MODE FOR CARRYING OUT THE INVENTION

Embodiments of the present invention will hereinafter be described with reference to the drawings.

### First Embodiment

An electric rotating machine of a first embodiment uses a rectangular wire capable of outputting high power and being downsized as described below; therefore, it is suitable, for example, to be used as a running motor for an electric vehicle. The electric rotating machine of the present invention can be applied to a pure electric vehicle driven only by an electric rotating machine and also to a hybrid vehicle driven by both an engine and an electric rotating machine. A description is below given of the hybrid vehicle by way of examples.

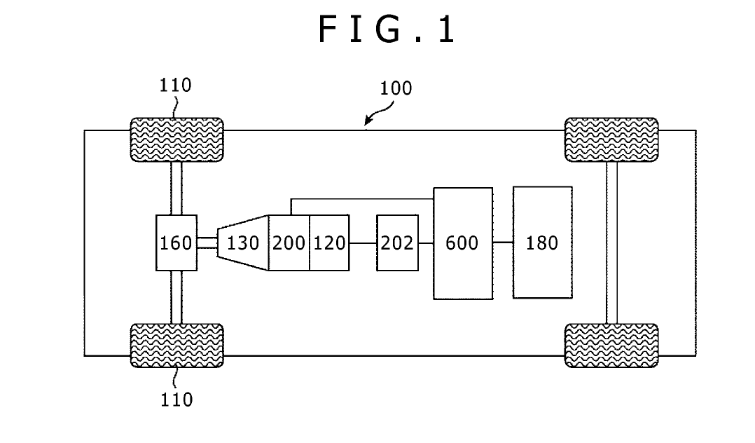

An engine 120, first and second electric rotating machines 200, 202 and a high-voltage battery 180 are mounted on a vehicle 100 as a hybrid automobile as illustrated in FIG. 1.

The battery 180 includes a secondary battery such as a lithium-ion battery and a nickel hydride battery. In addition, the battery 180 can output a high-voltage DC power of from 250 V to 600 V or more. When driving force from the electric rotating machines 200, 202 is needed, the battery 180 supplies DC power to the electric rotating machines 200, 202. During regenerative running, DC power is supplied from the electric rotating machines 200, 202. The DC power is transferred between the battery 180 and the electric rotating machines 200, 202 via a power converter 600.

Although not illustrated in the figure, a battery which supplies low-voltage power (e.g. 14V system power) is mounted on the vehicle.

Rotary torque produced by the engine 120 and the electric rotating machines 200, 202 is transmitted to front wheels 110 via a transmission 130 and a differential gear 160.

The electric rotating machines 200, 202 are structured in a similar manner, and the electric rotating machine 200 is hereunder described as a representative.

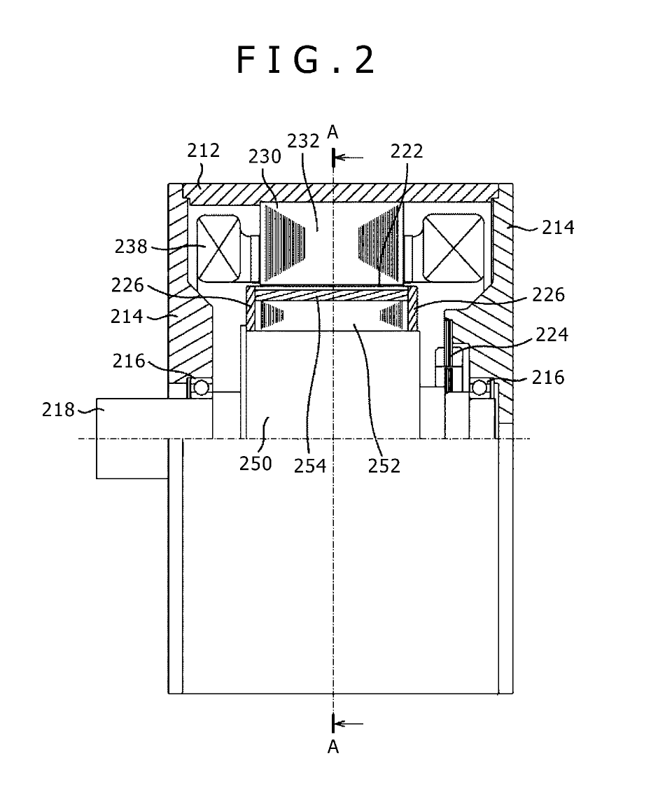

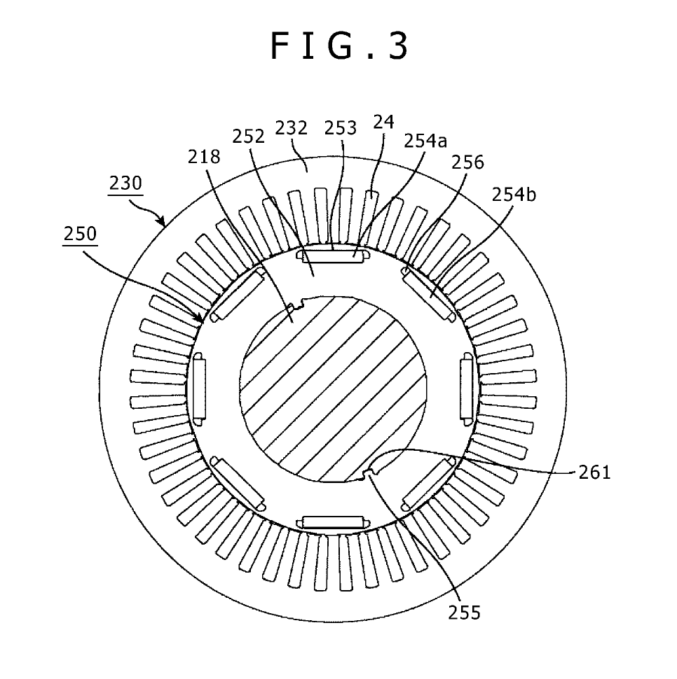

As illustrated in FIG. 2, the electric rotating machine 200 has a housing 212 and a stator 230 held inside the housing 212. The stator 230 includes a stator core 232 and a stator winding 238. A rotor 250 is rotatably held with an air gap 222 in-between inside the stator core 232. The rotor 250 includes a rotor core 252, a permanent magnet 254, and nonmagnetic stiffening plates 226. The stator core 252 is secured to a cylindrical shaft (a rotary axial body) 218. A direction along the rotational axis is referred to as “an axial direction”. A rotational direction around a rotational axis is referred to as “a circumferential direction”. A radiation direction toward the circumference from the rotational axis (for example, a direction toward the permanent magnet 254 from the rotational axis in FIG. 3) is referred to as “a radial direction”.

The housing 212 has a pair of end brackets 214 provided with respective bearings 216. The shaft 218 is rotatably held by way of these bearings 216. The shaft 218 is provided with a resolver 224 which detects the positions of poles and rotational speed of the rotor 250.

FIG. 3 is a cross-sectional view taken along symbol A-A in FIG. 2. The illustration of the housing 212 and the stator winding 238 is omitted in FIG. 3. A large number of slots 24 and teeth 236 are arranged uniformly over the full circle on the inner circumferential side of the stator core 232. Slot insulation (illustration is omitted) is provided in the slot 24. In addition, a plurality of phase windings of u- to w-phases constituting the stator winding 238 are attached in the slots. The present embodiment adopts distributed winding as a winding method for the stator winding 238.

Incidentally, not all the slots and the teeth are attached with reference numerals in FIG. 3. The teeth and the slots are partially attached with reference numerals as representatives.

Distributed winding is a winding method in which a phase winding is wound around the stator core 232 so as to be housed in two slots which are spaced apart from each other so as to straddle a plurality of slots 24. The present embodiment adopts the distributed winding as a winding method; therefore, magnetic flux distribution formed is nearly sinusoidal, which easily provides reluctance torque. Accordingly, control can be exercised in a wide range of rotation speed not only at low rotation speed but at high rotation speed by use of field-weakening control and reluctance torque. The distributed winding is suitable to provide motor characteristics for electric vehicles and other vehicles.

The rotor core 252 is bored with rectangular holes 253. Permanent magnets 254a, 254b (hereinafter, attached with reference numeral 254 as a representative) are embedded in the respective holes 253 and secured with an adhesive, for example. The hole 253 has a circumferential width set greater than that of the permanent magnet 254, so that magnetic air gaps 256 are defined on both sides of the permanent magnet 254. The magnetic air gap 256 may be filled with an adhesive. Alternatively, a molding resin may be hardened integrally with the permanent magnet 254 in the magnetic air gap 256. The permanent magnets 254 act as field poles of the rotor 250.

A magnetization direction of the permanent magnet 254 is oriented in a radial direction. The orientation of the magnetization direction is reversed for each field pole. More specifically, if the permanent magnet 254a has a N-pole in a surface on the stator side and a S-pole on a surface on the shaft side, then the permanent magnet 254b adjacent to the permanent magnet 254a has a S-pole in a surface on the stator side and a N-pole in a surface on the shaft side. In addition, these permanent magnets 254a, 254b are arranged alternately in the circumferential direction. In the present embodiment, eight of the permanent magnets 254 are arranged at regular intervals. The rotor 250 has eight poles.

Keys 255 are provided in the inner circumferential surface of the rotor core 252 at a predetermined interval so as to project therefrom. Meanwhile, key grooves 261 are provided in the outer circumferential surface of the shaft 218 so as to be concaved. The keys 255 are fitted to the corresponding key grooves 261 by means of clearance fit. Rotational torque is transmitted to the shaft 218 from the rotor 250.

The permanent magnet 254 may be embedded in the rotor core 252 after magnetization. Alternatively, the permanent magnet 254 may be inserted into the rotor core 252 before magnetization and may then be subjected to a strong magnetic field for magnetization. The permanent magnet 254 that has been magnetized is a strong magnet. If the permanent magnet 254 is magnetized before it will be secured to the rotor 250, a strong attraction occurs between the permanent magnet 254 and the rotor core 252 when the permanent magnet 254 is secured to the rotor 250. This attraction will disturb the operation. Because of the ¥strong attraction, dust such as iron powder is likely to adhere to the permanent magnet 254. Magnetizing the permanent magnet 254 that has been inserted into the rotor core 252 improves the productivity of the electric rotating machine more than magnetizing it before it is inserted.

Both the electric rotating machines 200, 202 are structured according to the first embodiment in the above description. However, one of the electric rotating machines 200 and 202 may be structured according to the first embodiment and the other may adopt other structures.

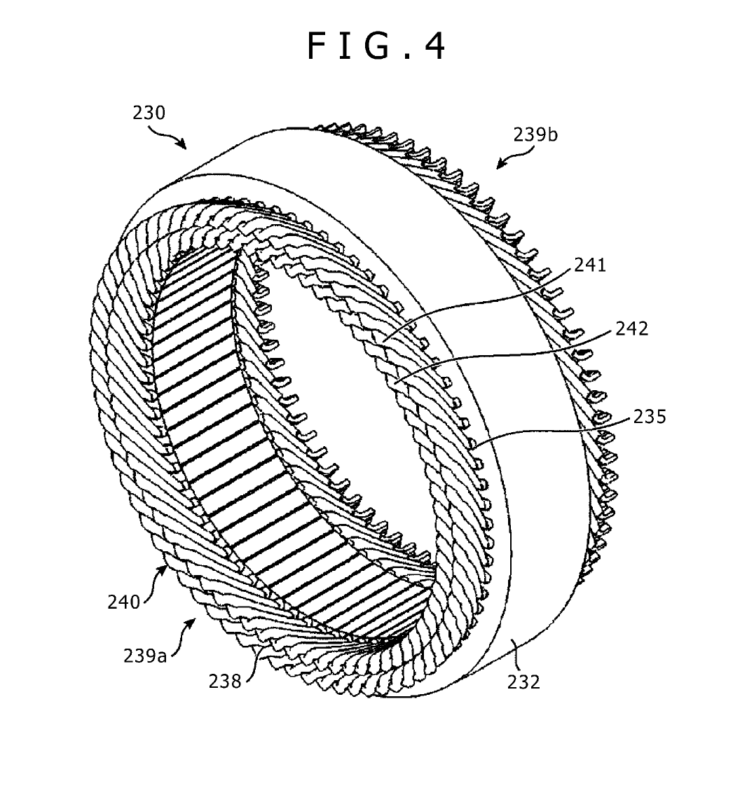

FIG. 4 is a perspective view of the stator 230 illustrated in FIGS. 2 and 3. The stator winding 238 is a rectangular wire. In the present embodiment, the rectangular wire is formed with a U-shaped portion (a turn portion) 240 by use of a mold or the like in advance, and is then axially inserted into the stator core 232 provided with a slot insulation 235. As the same time, straight portions are inserted into two corresponding slots which are spaced apart from each other so as to straddle a plurality of slots 24. Incidentally, FIG. 4 illustrates a welding side coil end 239b that has been twisted and formed, and does not illustrate and omits a lead wire, a neutral line, and other parts.

The above embodiment is just one of examples. The U-shaped portions can be formed by other methods. For example, a coil is fed by a predetermined distance with the use of a roller and is bent at a given position at a predetermined angle by means of a pin or the like. This operation is repeated, which can provide the same shape as that of the coil formed by the above-mentioned mold. After the formation, as with the above, the straight portions of the coil are axially inserted into the respective slots 24. In this instance, the U-shaped portion 240 of the stator winding 238 is not formed with the mold but formed as a result of being bent by means of a pin, for example.

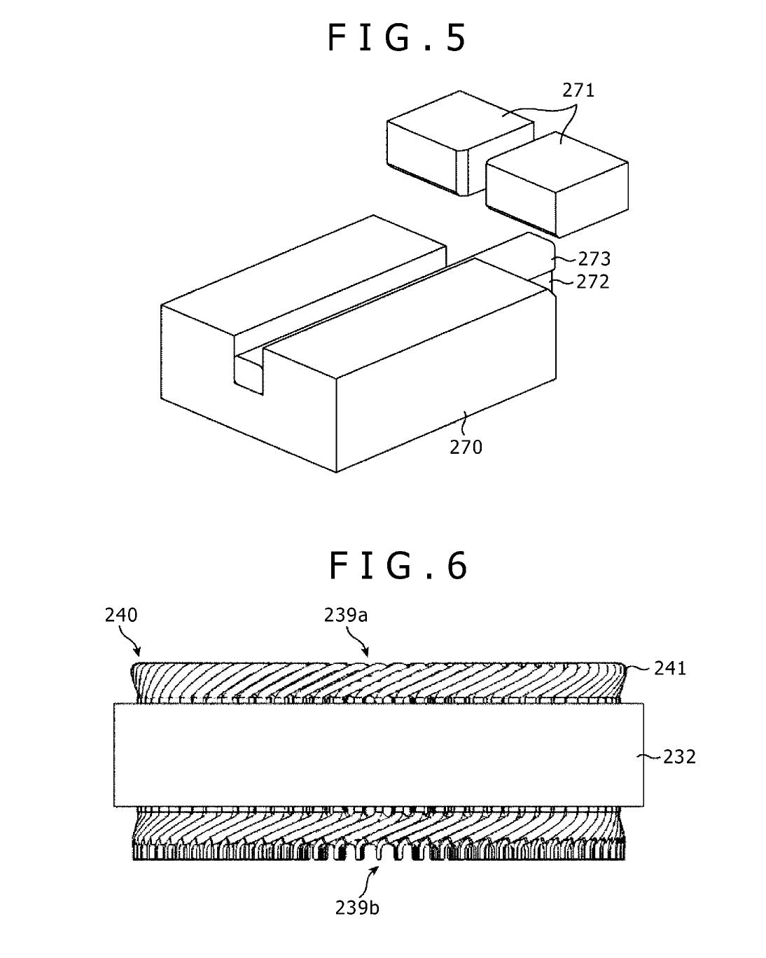

In the present embodiment, an insulation coated layer of the tip of the coil end 239b is removed by a press illustrated in FIG. 5. There are some methods for removing a coated layer, such as a method where a drug is used, in addition to the above method illustrated in FIG. 5. The present embodiment describes a method of peeling by means of a press.

As illustrated in FIG. 5, the peeling method performed in the present embodiment involves passing a rectangular wire 273 formed into a U-shape, or a rectangular wire 273 before formation, through a guide 270. The guide 270 fixes the rectangular wire 273 at a given position during the peeling. An upper mold 271 and a lower mold 272 are provided ahead of the guide 270. An insulation coated layer including a conductor portion of the rectangular wire 273 is removed to form a peeled portion. In this case, the peeled portion is thinner than a non-peeled portion provided with the insulation coated layer.

FIG. 6 illustrates the stator 230 as viewed in the radial direction. As seen in FIG. 6, outer-row windings 241 project from the stator core 232. In addition, as the outer-row windings 241 go toward the U-shaped portion 240 of a turn-back side coil end 239a, they are more broadened radially outward. This is performed to suppress the axial height of the turn-back side coil end 239a and to ensure a clearance between the coils.

Also in the welding side coil end 239b, the outer-row winding 241 is broadened in the radial direction in FIG. 6. This is based on the same concept as above. However, if the axial height and the coil clearance are sufficiently ensured, it is not necessarily needed to broaden the outer-row winding 241 in both the turn-back coil end and the welding side coil end.

In many cases as above, the U-shaped portion 240 of the turn-back side coil end 239a is broadened in the radial direction. In particular, the outer-row winding 241 will be more broadened radially outward than the inner-row winding 242.

The stator 230 is usually attached to the housing, a transmission case or the like. The attachment methods of the stator 230 include a method of thermally inserting the stator core 232 and a method in which the stator core 232 provided with a bolt insertion hole is bolted directly therethrough. If the stator 230 is attached to the housing or the like as described above, then the inside wall of the housing and the coil end 239 will come close to each other as illustrated in FIG. 2.

In particular, the inside wall of the housing and the outer-row winding 241 are in closest to each other. If a sufficient distance therebetween is not ensured, a problem with insulation quality may occur in some cases.

In order to solve the above-mentioned problem, it only needs to extend the inside diameter of the housing close to the outer-row winding 241. However, the outside diameter of the housing could be larger than necessary. Especially in an electric rotating machine for a hybrid automobile with no enough space, the housing is likely to interfere with other component parts.

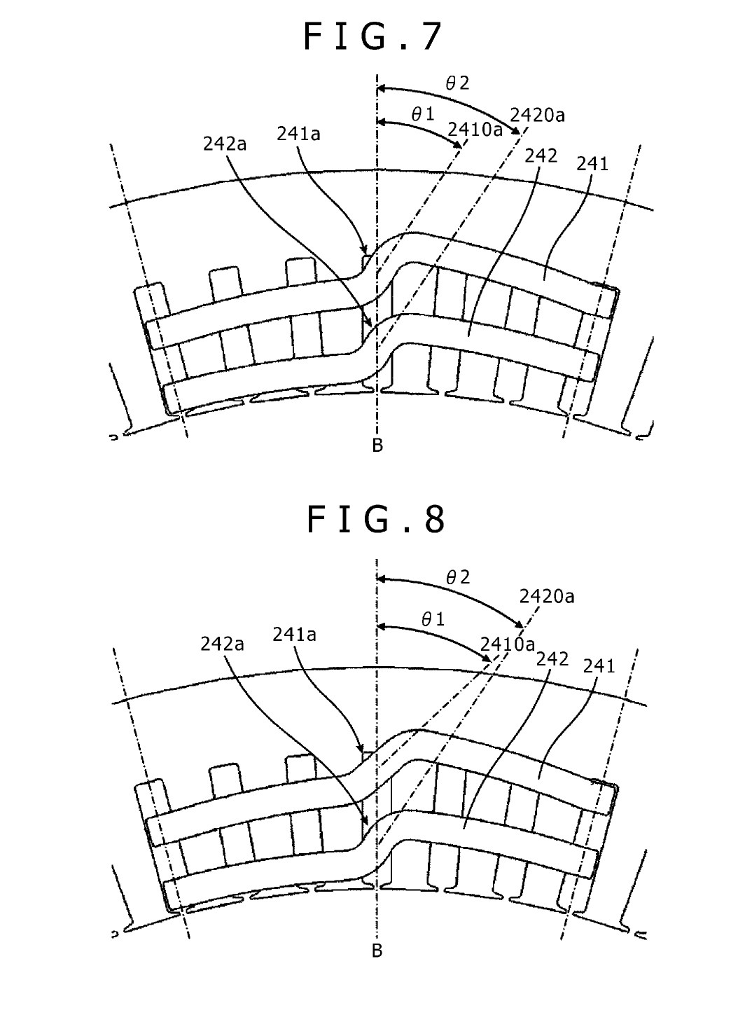

In the conventional outer-row winding 241 illustrated in FIG. 7, an angle (a layer-transition bent section angle) θ1 between a centerline B of both the windings and a centerline 2410a of a segment transition bent section 241a of the outer-row winding 241 is equal to an angle (a layer-transition bent section angle) θ2 between the centerline B and a centerline 2420a of a segment transition bent section 242a of the inner-row winding 242. In this case, the dielectric strength of the segment transition bent section 241a of the outer-row winding 241 is substantially equal to that of the segment transition bent section 242a of the inner-row winding 242.

Inter-coil clearances in this case are compared with each other. The outer-row winding 241 is located on the radially outside. Therefore, the inter-coil clearance of the outer-row winding 241 is larger than that of the inner-row winding 242. However, it is only needed to ensure the same clearance as that of the inner-row winding 242 if insulation quality is taken into account.

The present invention is characterized in that the layer-transition bent section angle θ1 of the outer-row winding 241 is greater than the layer-transition bent section angle θ2 of the inner-row winding 242 as illustrated in FIG. 8. Thus, the segment transition bent section 241a of the outer-row winding 241 can be made greater in dielectric strength than the segment transition bent section 242a of the inner-row winding 242.

In this way, the dielectric strength of the outer-row winding 241 that is the closest to the inside wall of the housing can be enhanced. It thereby makes it less possible to pose a problem with insulation quality between the inside wall of the housing and the outer-row winding 241.

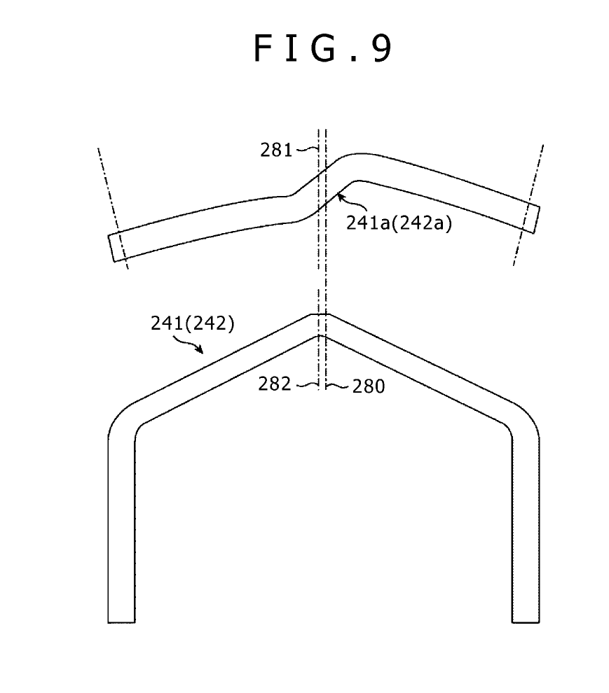

The extended layer-transition bent section angle θ1, however, will make the inter-coil clearance between the outer-row windings 241 non-uniform. With that, as illustrated in FIG. 9, the segment transition section center 280 and an inter-leg center 281 between legs inserted into slots are made positionally displaced from each other. Thus, the inter-coil clearance can minutely be adjusted. Alternatively, the segment transition section center 280 and a U-shaped portion top position 282 are made positionally displaced from each other. Also this can produce the same advantage.

FIG. 9 exemplifies the fact that the segment transition section center 280 of the outer-row winding 241 is made positionally displaced from the inter-leg center 281 between the legs or the U-shaped portion top position 282. However, the segment transition section center of the inner-row winding 242 may be displaced as well.

The centerline B of the above-mentioned inner-row winding 242 and the outer-row winding is a line connecting the inter-leg center 281 between the legs of the inner-row winding 242 to the inter-leg center 281 between the legs of the outer-row winding 241.

The layer-transition bent section angle θ1 can be set by applying the above so as to provide the same inter-coil clearance as that of the inner-row winding 242. In this manner, the layer-transition bent section angle θ1 can be made greater than the layer-transition bent section angle θ2. Thus, insulation quality between the outer-row winding 241 and the inside wall of the housing can be enhanced. Further, the inter-coil clearance of the outer-row winding 241 can be equal to that of the inner-row winding 2421; therefore, insulation quality between windings will not be degraded.

The windings are illustrated with the above description; however, the shape of the winding is not restrictive at all.

The description has been given of the motor for driving an automobile thus far by way of the examples. Nevertheless, the present invention can be applied to not only the motor for driving an automobile but also various motors. Further, it is to be noted that the present invention is not limited to the aforementioned embodiments, but covers various modifications. While, for illustrative purposes, those embodiments have been described specifically, the present invention is not necessarily limited to the specific forms disclosed. Thus, partial replacement is possible between the components of a certain embodiment and the components of another. Likewise, certain components can be added to or removed from the embodiments disclosed.

### EXPLANATION OF REFERENCE NUMERALS

24 Slot
100 Vehicle
110 Front wheel
120 Engine
130 Transmission
160 Differential gear
180 Battery
200, 202 Electric rotating machine
212 Housing
214 End bracket
216 Bearing
218 Shaft
222 Air gap
224 Resolver
226 Stiffening plate
230 Stator
232 Stator core
235 Slot insulation
236 Tooth
238 Stator winding
239 Coil end
240 U-shaped portion
241 Outer-row winding
242 Inner-row winding
250 Rotor
252 Rotor core
253 Hole
254 Permanent magnet
255 Key
256 Magnetic air gap
261 Key groove
270 Guide
271 Upper mold
272 Lower mold
273 Rectangular wire
280 Segment transition section center
281 Inter-leg center
282 U-shaped portion top position
600 Power converter
θ1, θ2 Layer-transition bent section angle

1. An electric rotating machine, comprising:
a stator including a stator core and a stator winding, the stator core having a plurality of slots rowed in a circumferential direction, the stator winding being formed of a conductor rectangular in a cross section and being inserted into the slots, the conductor being provided with an insulating coated layer,
wherein the stator winding has a first segment transition bent section provided on a radially outside of the stator and a second segment transition bent section provided on a radially inside of the stator, and
the first segment transition bent section has a layer-transition bent section angle greater than does the second segment transition bent section.

2. The electric rotating machine according to claim 1,
wherein a central bending of a layer-transition bent section of the first segment transition bent section or the second segment transition bent section is different from a center between leg portions of the segments inserted into the respective slots.

3. The electric rotating machine according to claim 1,
wherein a central bending of a layer-transition bent section of the first segment transition bent section or the second segment transition bent section is positionally different from a top of a U-shaped portion.

4. The electric rotating machine according to claim 1,
wherein the stator core is formed by a mold.

5. The electric rotating machine according to claim 1,
wherein the stator core having a hole adapted to receive a bolt passing through the hole is attached to at least one of a housing and a case by means of a bolt.

6. The electric rotating machine according to claim 1,
wherein the stator core is shrinkage-fitted to at least one of a housing and a case.
